(19) United States
(12) Patent Application Publication
(10) Pub. No.: US 2022/0058269 A1
(43) Pub. Date: Feb. 24, 2022

(54) SYSTEMS AND METHODS FOR MANAGING A TRUSTED APPLICATION IN A COMPUTER CHIP MODULE

(71) Applicant: Telit Communications S.p.A., Sgonico (Trieste) (IT)

(72) Inventors: Mihai VOICU, Boca Raton, FL (US); Martino TURCATO, Vicenza (IT)

(73) Assignee: Telit Communications S.p.A., Sgonico (Trieste) (IT)

(21) Appl. No.: 17/415,558

(22) PCT Filed: Dec. 19, 2019
(86) PCT No.: PCT/IB2019/001445

§ 371 Date: Jun. 17, 2021

Related U.S. Application Data
(60) Provisional application No. 62/782,062, filed on Dec. 19, 2018.

(51) Int. Cl. G06F 21/57; G06F 21/12; G06F 21/31; G06F 21/60; G06F 21/62; H04L 29/06

(52) U.S. Cl. CPC G06F 21/572; G06F 21/121; G06F 21/31; H04L 63/0876; G06F 21/6218; H04L 63/0442; G06F 21/602

(57) ABSTRACT

Systems and methods for managing a trusted application in a computer chip module include generating a trusted application package (TAP), the TAP comprising an application and an activation code, wherein the TAP is encrypted with a passcode and wherein the activation code is stored in the memory of the computer; receiving from the computer chip module a public key, wherein the public key is part of a pair of asymmetrical transport keys generated by the computer chip module, and wherein the pair of asymmetrical transport keys further comprises a private key; encrypting the passcode with the public key; transmitting the encrypted passcode to the computer chip module, wherein the computer chip module is configured to decrypt the passcode using the private key; and transmitting the TAP to the computer chip module, wherein the TAP is stored in a dedicated folder on the computer chip module.

### CROSS-REFERENCE TO RELATED APPLICATIONS

The present application claims benefit from provisional application No. 62/782,062 filed on Dec. 19, 2018, and entitled “MANAGING TRUSTED APPLICATION IN MODULES,” which is incorporated by reference herein in its entirety.

### FIELD OF THE INVENTION

The invention relates generally to managing trusted applications, and more specifically to systems and methods for managing a trusted application in a computer chip module.

### BACKGROUND OF THE INVENTION

“Internet of Things” (IoT) is an inter-connected network of communication devices (e.g., “smart” devices) with electronics, sensors, software and network connectivity. IoT devices may be deployed to monitor technical devices, such as, automobiles, security systems, medical devices including biological implants, home appliances, etc. IoT devices may measure and/or gather data about the environment in which they are deployed. An IoT communication device may have a telecommunication transceiver or modem which allows the IoT communication device to transmit and/or receive data to/from a monitoring device over a wireless network, such as the Internet, are may have a hard-wired, serial connection or other local interface. IoT devices may include chipsets or computer modules (e.g. including one or more chips), such as the ME910C1-E2 series of chipsets produced by Telit, Inc., that enable the device to communicate with a communications network such as a cellular network or other network.

IoT devices may have applications installed in their computer chip modules which enable various functionalities as required, such as, for example, monitoring, communication, etc. These applications may be preinstalled or may be installed remotely, e.g., by a service provider, vendor, etc. However, present IoT devices provide no ability for service providers to control how and when such applications are installed, run, read, and/or deleted from the device, and/or to protect against misuse by the owner of the device or a malicious third-party.

### SUMMARY OF THE INVENTION

Various embodiments of the invention include systems and methods for managing a trusted application in a computer chip module. Some embodiments may include a computer having a processor and memory, and one or more code sets stored in the memory and executing in the processor, which configure the processor to: generate a trusted application package (TAP), the TAP comprising an application and an activation code, in which the TAP is encrypted with a passcode and in which the activation code is stored in the memory of the computer; receive from the computer chip module a public key, in which the public key is part of a pair of asymmetrical transport keys generated by the computer chip module, and in which the pair of asymmetrical transport keys further comprises a private key; encrypt the passcode with the public key; transmit the encrypted passcode to the computer chip module, in which the computer chip module is configured to decrypt the passcode using the private key; and transmit the TAP to the computer chip module, in which the TAP is stored in a dedicated folder on the computer chip module.

In some embodiments of the invention, the transmissions are via a wireless network. In some embodiments, the transmissions are via at least one of a local interface and a physically connected serial connection. In some embodiments, the passcode is stored in a cryptographic storage on the computer chip module. In some embodiments, the processor is further configured to: retrieve the activation code from the memory; and transmit a run command and the activation code to the computer chip module; in which, upon receiving the run command and the activation code, the computer chip module is configured to: retrieve the passcode from the cryptographic storage; retrieve the TAP from the dedicated folder; decrypt the TAP using the passcode; compare the activation code transmitted with the run command with the activation code in the TAP; and

execute the application only when the two activation codes are identical.

In some embodiments, the application is executed in a dedicated application environment in the computer chip module. In some embodiments, the processor is further configured to: retrieve the activation code from the memory; and transmit a read command and the activation code to the computer chip module; in which, upon receiving the read command and the activation code, the computer chip module is configured to: retrieve the passcode from the cryptographic storage; retrieve the TAP from the dedicated folder; decrypt the TAP using the passcode; compare the activation code transmitted with the read command with the activation code in the TAP; and read the application only when the two activation codes are identical.

In some embodiments, the processor is further configured to: retrieve the activation code from the memory; and transmit an override/write command and the activation code to the computer chip module; in which, upon receiving the override/write command and the activation code, the computer chip module is configured to: retrieve the passcode from the cryptographic storage; retrieve the TAP from the dedicated folder; decrypt the TAP using the passcode; compare the activation code transmitted with the override/write command with the activation code in the TAP; and at least one of override and write to the application only when the two activation codes are identical.

In some embodiments, the processor is further configured to: retrieve the activation code from the memory; and transmit a delete command and the activation code to the computer chip module; in which, upon receiving the delete command and the activation code, the computer chip module is configured to: retrieve the passcode from the cryptographic storage; retrieve the TAP from the dedicated folder; decrypt the TAP using the passcode; compare the activation code transmitted with the delete command with the activation code in the TAP; and delete the application from the dedicated folder only when the two activation codes are identical.

In some embodiments, the computer chip module is integrated in an Internet-of-Things (IoT) device.

These and other aspects, features and advantages will be understood with reference to the following description of certain embodiments of the invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a high-level diagram illustrating an example configuration of a system for managing a trusted application in a computer chip module, according to at least one embodiment of the invention;

FIG. 2 is a high-level diagram illustrating an example method for generating a Trusted Application Package (hereinafter “TAP”), according to at least one embodiment of the invention;

FIG. 3 is a high-level overview diagram illustrating an example method 300 for loading a TAP into a computer chip module, according to at least one embodiment of the invention;

FIG. 4 is a high-level overview diagram illustrating an example method for deleting a TAP from a computer chip module, according to at least one embodiment of the invention.

FIG. 5 is a high-level diagram illustrating an example configuration of a method workflow for loading an application when managing a trusted application in a computer chip module.

FIG. 6 is a high-level diagram illustrating an example configuration of a method workflow for executing an application when managing a trusted application in a computer chip module, according to at least one embodiment of the invention; and

FIG. 7 is a high-level diagram illustrating an example configuration of a method workflow for deleting an application when managing a trusted application in a computer chip module, according to at least one embodiment of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory processor-readable storage medium that may store instructions, which when executed by the processor, cause the processor to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof may occur or be performed simultaneously, at the same point in time, or concurrently.

Embodiments of the invention provide systems and methods for managing a trusted application in a computer chip module. For example, embodiments of the invention enable a user (e.g., a customer, vendor, service provider, etc.) to manage and control how and when applications are written to, installed, run, read, and/or deleted from a computer chip module installing in or otherwise integrated with an IoT device, and/or to protect against misuse by the owner/user/possessor of the device or a malicious third-party. Such applications, which enable various functionalities as required, such as, for example, monitoring, communication, etc., are referred to herein as trusted applications owing to the trusted nature of the manager of the application residing on the computer chip module in the IoT device.

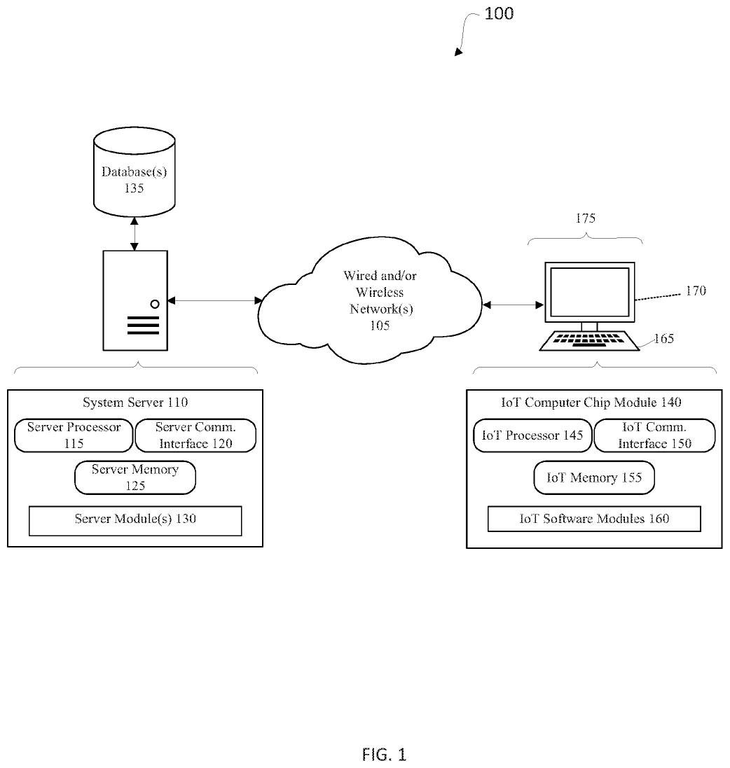

FIG. 1 shows a high-level diagram illustrating an example configuration of a system 100 for managing a trusted application in a computer chip module, according to at least one embodiment of the invention. System 100 includes network 105, which may include a private operational network, the Internet, one or more telephony networks, one or more network segments including local area networks (LAN) and wide area networks (WAN), one or more wireless networks, one or more local interfaces, one or more physically connected (e.g., serial connection) interfaces, and/or a combination thereof. For example, in some embodiments network 105 may include a dedicated IoT wireless network platform and/or a local command interface (e.g., in a customer's environment). In some embodiments, system 100 may include a system server 110 constructed in accordance with one or more embodiments of the invention. In some embodiments, system server 110 may be a stand-alone computer system. In other embodiments, system server 110 may include a decentralized network of operatively connected computing devices, which communicate over network 105. Therefore, system server 110 may include multiple other processing machines such as computers, and more specifically, stationary devices, mobile devices, terminals, and/or computer servers (collectively, “computing devices”). Communication with these computing devices may be, for example, direct or indirect through further machines that are accessible to the network 105.

System server 110 may be any suitable computing device and/or data processing apparatus capable of communicating with computing devices, other remote devices or computing networks, receiving, transmitting and storing electronic information and processing requests as further described herein. System server 110 is therefore intended to represent various forms of digital computers, such as laptops, desktops, workstations, personal digital assistants, servers, blade servers, edger servers, mainframes, and other appropriate computers and/or networked or cloud-based computing systems capable of employing the systems and methods described herein.

In some embodiments, system server 110 may include a server processor 115 which is operatively connected to various hardware and software components that serve to enable operation of the system 100. Server processor 115 may serve to execute instructions to perform various operations relating to various functions of embodiments of the invention as described in greater detail herein. Server processor 115 may be one or a number of processors, a central processing unit (CPU), a graphics processing unit (GPU), a multi-processor core, or any other type of processor, depending on the particular implementation.

System server 110 may be configured to communicate via communication interface 120 with various other devices connected to network 105. For example, communication interface 120 may include but is not limited to, a modem, a Network Interface Card (NIC), an integrated network interface, a radio frequency transmitter/receiver, e.g., Bluetooth wireless connection, cellular, 5G, Near-Field Communication (NFC) protocol, Narrowband Internet of Things (NB-IoT), a satellite communication transmitter/receiver, an infrared port, a USB connection, and/or any other such interfaces for connecting the system server 110 to other computing devices and/or communication networks such as private networks and the Internet.

In certain implementations, a server memory 125 may be accessible by server processor 115, thereby enabling server processor 115 to receive and execute instructions such a code, stored in the memory and/or storage in the form of one or more software modules 130, each module representing one or more code sets. The software modules 130 may include one or more software programs or applications (collectively referred to as the “server application”) having computer program code or a set of instructions executed partially or entirely in server processor 115 for carrying out operations for aspects of the systems and methods disclosed herein, and may be written in any combination of one or more programming languages. Server processor 115 may be configured to carry out embodiments of the present invention by, for example, executing code or software, and may execute the functionality of the modules as described herein. The one or more software modules 130 may be executed by server processor 115 to facilitate interaction and/or various execute functionalities between and among system server 110 and the various software and hardware components of system 100, such as, for example, server database(s) 135 and IoT computer chip module(s) 140, IoT device 175, as described herein.

Of course, in some embodiments, server module(s) 130 may include more or less actual modules which may be executed to enable these and other functionalities of the invention. The modules described herein are therefore intended to be representative of the various functionalities of system server 110 in accordance with some embodiments of the invention. It should be noted that in accordance with various embodiments of the invention, server module(s) 130 may be executed entirely on system server 110 as a stand-alone software package, partly on system server 110 and partly on one or more of IoT Computer Chip Module 140, or entirely on IoT Computer Chip Module 140.

Server memory 125 may be, for example, a random access memory (RAM) or any other suitable volatile or non-volatile computer readable storage medium. Server memory 125 may also include storage which may take various forms, depending on the particular implementation. For example, the storage may contain one or more components or devices such as a hard drive, a flash memory, a rewritable optical disk, a rewritable magnetic tape, or some combination of the above. In addition, the memory and/or storage may be fixed or removable. In addition, memory and/or storage may be local to the system server 110 or located remotely.

In accordance with further embodiments of the invention, system server 110 may be connected to one or more database(s) 135, for example, directly or remotely via network 105. Database 135 may include any of the memory configurations as described herein, and may be in direct or indirect communication with system server 110. In some embodiments, database 135 may store information related to one or more aspects of the invention.

As described herein, among the computing devices on or connected to the network 105 may be one or more IoT Computer Chip Modules 140. IoT Computer Chip Module 140 may be or may be part of any standard computing device. As understood herein, in accordance with one or more embodiments, a computing device may be a stationary computing device, such as a desktop computer, kiosk and/or other machine, each of which generally has one or more processors, such as IoT processor 145, configured to execute code to implement a variety of functions, a IoT communication interface 150, for connecting to the network 105, a computer-readable memory, such as IoT memory 155, one or more IoT software modules, such as IoT software module 160, one or more input devices, such as input devices 165, and one or more output devices, such as output devices 170. Typical input devices, such as, for example, input devices 165, may include a keyboard, pointing device (e.g., mouse or digitized stylus), a web-camera, and/or a touch-sensitive display, etc. Typical output devices, such as, for example output device 170 may include one or more of a monitor, display, speaker, printer, etc.

In some embodiments, as described herein, IoT device 175 may be any electronic device (e.g., a thermostat, a car, a pacemaker, etc.) that uses communication interface 150 to connect to network 105 to transmit and/or receive data. In some embodiments, IoT device 175 has installed or otherwise integrated therein IoT Computer Chip Module 140, which pay provide various processing and/or communication functionalities to and for the IoT device 175. In some embodiments, IoT processor 145, IoT communication interface 150, IoT memory 155, and IoT software module 160, may be integrated in a single chipset or computer module (e.g. including one or more chips), such as the ME910C1-E2 series of chipsets produced by Telit, Inc., that enable the IoT device 175 to communicate with a communications network such as a cellular network or other network (e.g., Network 105). In some embodiments, the various input devices 165 and output device 170 may be integrated with or otherwise part of IoT device 175, and/or may communicate with IoT Computer Chip Module 140.

In some embodiments, IoT software module 160 may be executed by IoT processor 145 to provide the various functionalities of IoT Computer Chip Module 140. In particular, in some embodiments, IoT software module 160 may provide a user interface with which a user of IoT Computer Chip Module 140 (and/or IoT device 175) may interact, to, among other things, communicate with system server 110.

Additionally or alternatively, a computing device may be a mobile electronic device (“MED”), which is generally understood in the art as having hardware components as in the stationary device described above, and being capable of embodying the systems and/or methods described herein, but which may further include componentry such as wireless communications circuitry, gyroscopes, inertia detection circuits, geolocation circuitry, touch sensitivity, among other sensors. Non-limiting examples of typical MEDs are smartphones, personal digital assistants, tablet computers, and the like, which may communicate over cellular, NB-IoT, and/or Wi-Fi networks or using a Bluetooth or other communication protocol. Typical input devices associated with conventional MEDs include sensors, keyboards, microphones, accelerometers, touch screens, light meters, digital cameras, and the input jacks that enable attachment of further devices, etc.

In some embodiments, IoT Computer Chip Module 140 and/or IoT device 175 may be a “dummy” terminal, by which processing and computing may be performed on or primarily on system server 110, and information may then be provided to IoT Computer Chip Module 140 via server communication interface 120 for display and/or basic data manipulation. In some embodiments, modules depicted as existing on and/or executing on one device may additionally or alternatively exist on and/or execute on another device. For example, in some embodiments, one or more modules of server module 130, which is depicted in FIG. 1 as existing and executing on system server 110, may additionally or alternatively exist and/or execute on IoT Computer Chip Module 140. Likewise, in some embodiments, one or more modules of IoT software module 160, which is depicted in FIG. 1 as existing and executing on IoT Computer Chip Module 140, may additionally or alternatively exist and/or execute on system server 110.

In some embodiments, IoT memory 155 may include one or more dedicated folders for storing data (e.g., applications, trusted application packages (as described herein), data collected by IoT device 140, etc.). In some embodiments, the one or more dedicated folders may be a flash partition in the memory of the device. In some embodiments, IoT memory 155 may include cryptographic storage (e.g., a digital vault, etc.) for storing sensitive data or data otherwise requiring a higher degree of protection against unauthorized access (e.g., passcodes, etc.).

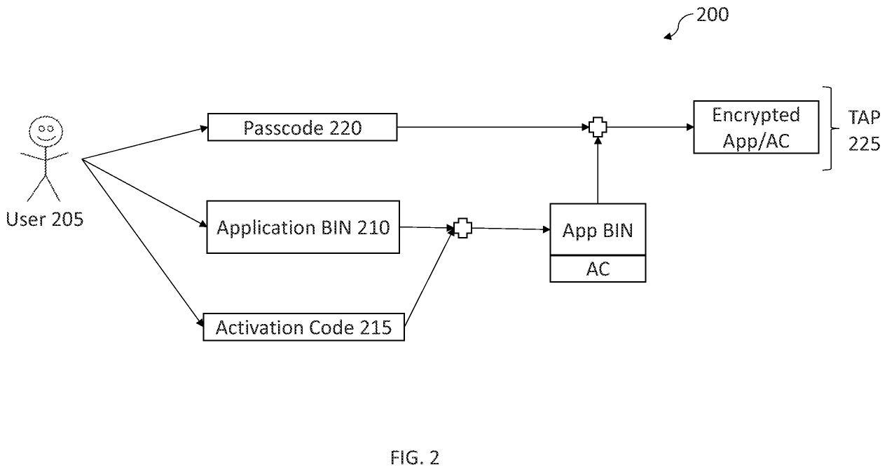

FIG. 2 is a high-level diagram illustrating an example method 200 for generating a Trusted Application Package (hereinafter “TAP”), as described in detail herein, according to at least one embodiment of the invention. As understood herein, a TAP is a secure package of data that includes at least two primary elements, (1) an application (e.g., and application binary), and (2) an activation code, and is encrypted using a passcode. As shown in FIG. 2, when a user 205 (e.g., a customer, service provider, vendor, etc., using, e.g., system server 110) desires to manage a trusted application on a computer chip module (e.g., IoT Computer Chip Module 140 in IoT device 175), an application 210 may be combined with activation code 215, and encrypted with passcode 220, to create TAP 225.

As understood herein, application 210 may be any program, code, software, etc., capable of being installed and executed in IoT device 140. As understood herein, activation code 215 may be any unique or selected code (e.g., a combination of alphanumeric characters, or other string, etc.), which may be appended to or otherwise combined with the application 210. As described in further detail herein, activation code 215 may be used by embodiments of the invention to ensure the trustworthiness of application 210 and the various commands used when communicating with application 210 while it resides in IoT Computer Chip Module 140 (e.g., in the computer chip module installed in IoT device 175). For example, in some embodiments, each operation/command (e.g., AT #M2M Write/Del/Run/Read) must use an activation code when executed which matches the activation code 215 in the TAP.

In various embodiments, activation code 215 may be user-generated (e.g., based on a user input), manually generated, automatically generated (e.g., by system server 110), etc. In various embodiments, passcode 220 may be user-generated (e.g., based on a user input), manually generated, automatically generated (e.g., by system server 110), etc. In some embodiments, passcode 220 may be used to encrypt application 210 and activation code 215 using one of a variety of standard encryption protocols and methods, as understood by those skilled in the art. In some embodiments, each application must be sent to the IoT Computer Chip Module 140 (e.g., in IoT device 175) encrypted and signed by the user or a system manager, as a security control. Once the TAP has been generated it may be loaded into or otherwise transferred to the IoT Computer Chip Module 140 (e.g., to the IoT computer chip module 140 in IoT device 175), via network 105.

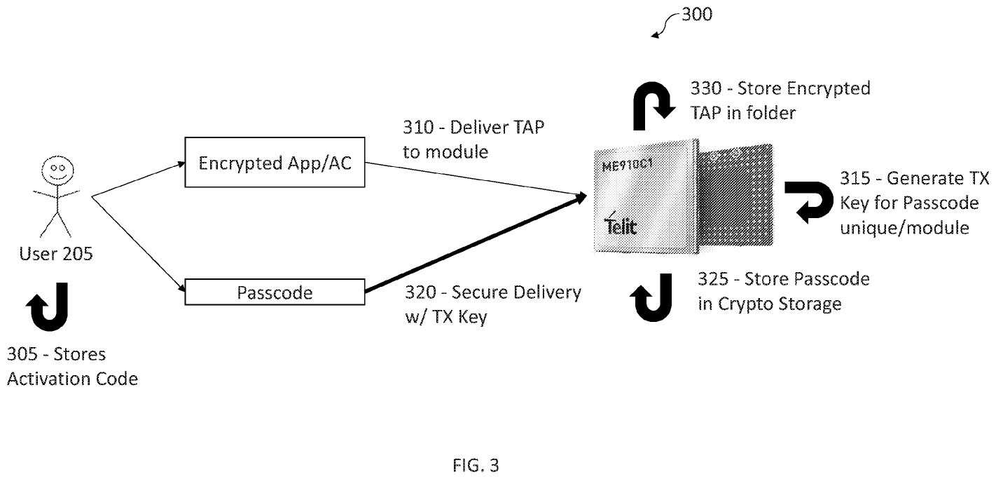

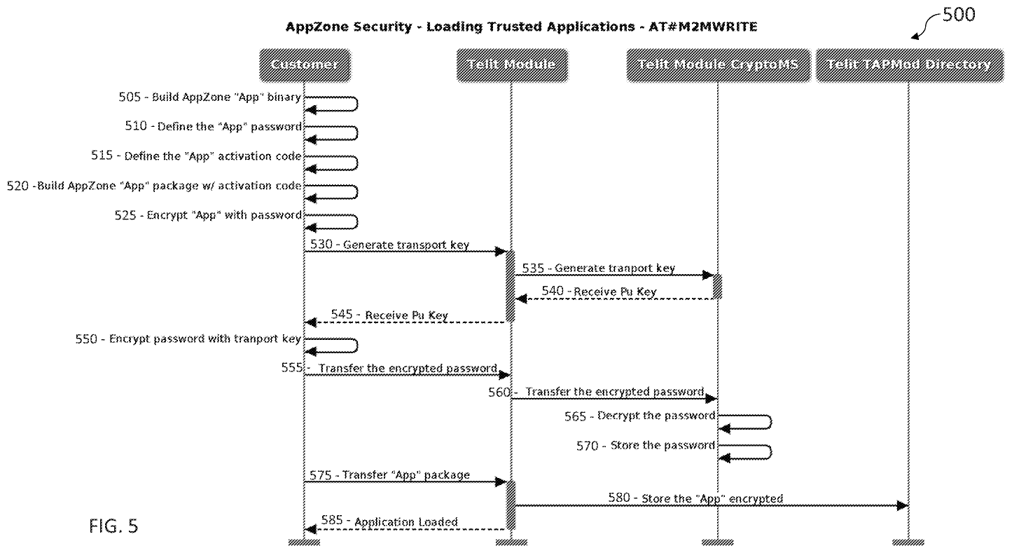

FIG. 3 is a high-level overview diagram illustrating an example method 300 for loading a TAP into a computer chip module, according to at least one embodiment of the invention. Once TAP 225 has been generated (see FIG. 2), at step 305, in some embodiments, the system processor (e.g., server processor 115) is configured to store activation code 215, e.g., in server memory (e.g., server memory 125) or in a database (e.g., database 135), where it can be later retrieved and used as described herein. Next, at step 310, in some embodiments, the server processor 115 is configured to transfer, send, or otherwise deliver TAP 225 to IoT Computer Chip Module 140, e.g., via network 105. It should be noted that while in the embodiments described in FIG. 3, TAP 225 is shown as being sent prior to passcode 220, in other embodiments passcode 220 may be sent prior to TAP 225 (see, e.g., embodiments of FIG. 5, herein).

In some embodiments, at step 315, IoT computer chip module 140 may be configured to generate a pair of asymmetrical transport keys (e.g., a public key and private key, using asymmetric key cryptography), and the public key may then be transmitted to the system server 110 to facilitate transferring passcode 220 to IoT computer chip module 140, as described in further detail with reference to FIG. 5 herein.

Briefly, asymmetric key cryptography refers to a cryptographic algorithm which requires two separate keys, one of which is secret (or private) and one of which is public. Although different, the two parts of this key pair are mathematically linked. The public key is used to encrypt a message or data (referred to as plaintext or cleartext) or to verify a digital signature; whereas the private key is used to decrypt the encrypted data (referred to as ciphertext) or to create a digital signature. The term “asymmetric” stems from the use of different keys to perform these opposite functions, each the inverse of the other—as contrasted with conventional (“symmetric”) cryptography which relies on the same key to perform both the encryption and decryption. The strength of asymmetric cryptography lies in the fact that it is “impossible” (computationally infeasible) for a properly generated private key to be determined from its corresponding public key. Thus, the public key may be published or otherwise left unprotected without compromising security, whereas the private key must not be revealed to anyone not authorized to decrypt the data or perform digital signatures.

At step 320, in some embodiments, server processor 115 may be configured to encrypt the passcode 220 with the public transport key received from IoT computer chip module 140, and securely deliver the passcode to IoT computer chip module 140. At step, 325, in some embodiments, IoT processor 145 may be configured to decrypt passcode 220 (e.g., using the private key of the asymmetric cryptographic key pair) and store passcode 220 in a cryptographic storage, e.g., in IoT memory 160, and at step 330, in some embodiments, IoT processor 145 may be configured to store TAP 225 in a dedicated folder for future use. It should be understood that the order in which the passcode and the TAP are stored may vary depending on the embodiment.

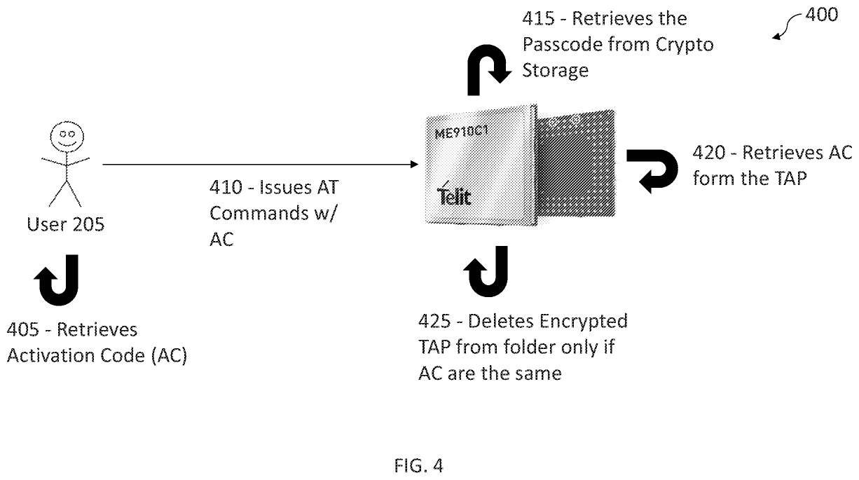

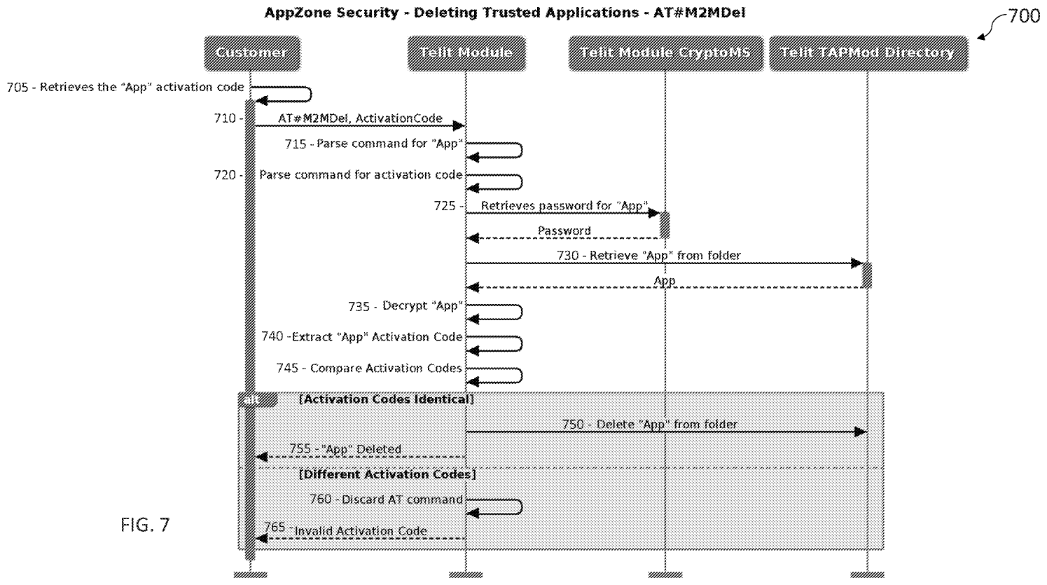

FIG. 4 is a high-level overview diagram illustrating an example method 400 for deleting a TAP from a computer chip module, according to at least one embodiment of the invention. A step 405, in some embodiments, the system processor (e.g., server processor 115) is configured retrieve the stored activation code 215 from where it was previously stored, e.g., from server memory (e.g., server memory 125) or a database (e.g., database 135). Next, at step 410, in some embodiments, the server processor 115 is configured to send a delete command (e.g., an AT command such as AT #M2MDel) along with the retrieved activation code 215 to IoT Computer Chip Module 140, e.g., via network 105 (see, e.g., embodiments of FIG. 7, herein). At step, 415, in some embodiments, IoT processor 145 may be configured to retrieve passcode 220 from the cryptographic storage in which it was previously stored (e.g., in IoT memory 160), and at step 420, in some embodiments, IoT processor 145 may be configured to retrieve activation code 215 from TAP 225, which was previously stored in the dedicated folder. It should be understood that the order in which the passcode and the activation code are retrieved may vary depending on the embodiment. Finally, in some embodiments, at step 425, the IoT processor 145 may be configured compare the activation code sent with the delete command and the activation code retrieved from the stored TAP, and to delete the application from the dedicated folder only when the two activation codes are identical.

FIG. 5 is a high-level diagram illustrating an example configuration of a method workflow 500 for loading an application when managing a trusted application in a computer chip module. In some embodiments, at step 505, a processor, e.g., server processor 115, of a user (e.g., user 205) may be configured (e.g., using one or more code sets stored in the memory and executing in the processor) to build or otherwise compile an application 210 (e.g., an application binary file, such as are used, for example, in the Telit® IoT AppZone, or any environment for running applications on IoT computer chip module 140). At step 510, in some embodiments, server processor 115 may be configured to define, receive, retrieve, or generate, a passcode, e.g., passcode 220 (e.g., a password to be used in encrypting the application). At step 515, in some embodiments, server processor 115 may be configured to define, receive, retrieve, or generate, an activation code, e.g., activation code 215 (e.g., a code to be used in conjunction with a command in managing application in the computer chip module). In some embodiments, the system processor (e.g., server processor 115) may be configured to store activation code 215, e.g., in server memory (e.g., server memory 125) or in a database (e.g., database 135), where it can be later retrieved and used as described herein. At step 520, in some embodiments, server processor 115 may be configured to build, construct, compile, package or otherwise join the application 210 together with the activation code 215. At step 525, in some embodiments, server processor 115 may be configured to encrypt the application/activation code package using the passcode 220, thereby generating a trusted application package (TAP) which includes (at minimum) application 210 and an activation code 215 encrypted with a the passcode 220.

Next, at step 530, in some embodiments, server processor 115 may be configured to instruct or otherwise send a request to IoT processor 145 to generate a pair of asymmetrical transport keys (e.g., a public key and private key, using asymmetric key cryptography, as described herein), to enable secure transfer of the passcode 220 to the IoT computer chip module 140. At step 535, in some embodiments, the IoT processor 145 may be configured to generate the asymmetric transport key pair and store the private key in the cryptographic storage (e.g., a digital vault, such as the Telit® Module CryptoMS), and at step 540, in some embodiments, the IoT processor 145 may be configured to send the public key to the server (e.g., to system server 110).

At step 545, server processor 115 may be configured to receive the public key from the IoT computer chip module 140, and step 550, in some embodiments, server processor 115 may be configured to encrypt the passcode 220 with the public key. Next, at step 555, server processor 115 may be configured to transmit the encrypted passcode 220 to the IoT computer chip module 140, and at step 560, the IoT processor 145 may be configured to transfer the encrypted passcode 220 to the cryptographic storage. At step 565, in some embodiments, IoT processor 145 may be configured to decrypt the passcode 220 using the private key stored in the cryptographic storage, and at step 570 the decrypted passcode may be stored in the cryptographic storage.

At step 575, in some embodiments, server processor 115 may be configured to transmit the TAP 225 to IoT computer chip module 140, and at step 580, in some embodiments, the encrypted TAP (e.g., encrypted with the passcode 220) may be stored in a dedicated folder on the IoT computer chip module 140 (such as, for example, a Telit® TAPMod Directory folder). Finally, at step 585, in some embodiments, a message or other indication may be sent to system server 110, indicating that the application has been loaded on IoT computer chip module 140.

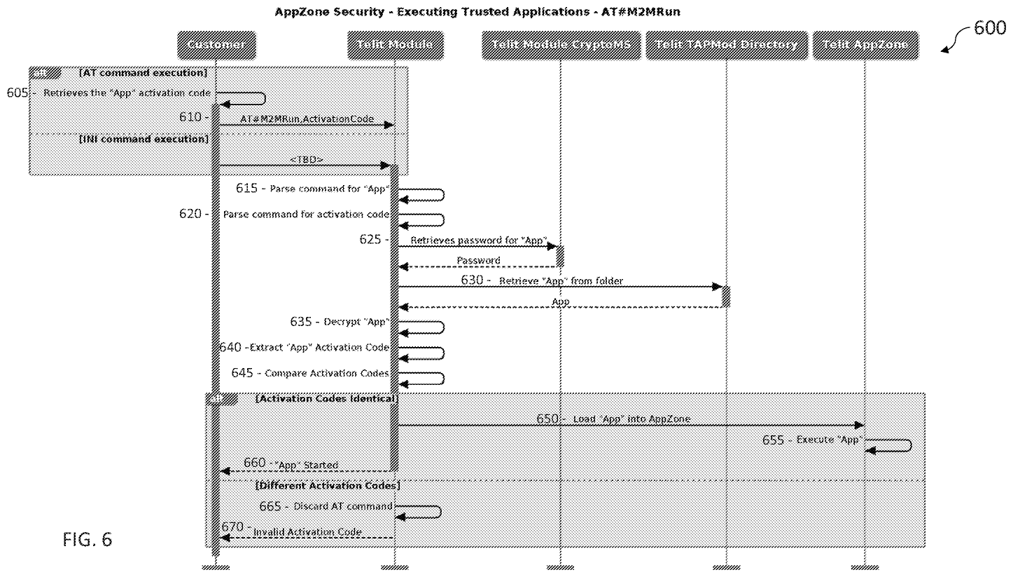

FIG. 6 is a high-level diagram illustrating an example configuration of a method workflow 600 for executing an application when managing a trusted application in a computer chip module, according to at least one embodiment of the invention. In some embodiments, at step 605, a processor, e.g., server processor 115, of a user (e.g., user 205) may be configured (e.g., using one or more code sets stored in the memory and executing in the processor) to retrieve the previously stored activation code, e.g., activation code 215, from storage. At step 610, in some embodiments, server processor 115 may be configured to transmit a run command and the activation code 215 to IoT computer chip module 140 to run the trusted application stored on IoT computer chip module 140. For example, the command may be an AT command such as AT #M2MRun (e.g., for wireless communication commands), along with the retrieved activation code 215. Of course, other commands are also contemplated, e.g., when communications are facilitated via a local interface or physically connected (serial) connection/interface. At step 615, in some embodiments, IoT processor 145 may be configured to parse the received command to identify the application 210, and at step 620, in some embodiments, IoT processor 145 may be configured to parse the received command to identify the received activation code 215.

Next, at step 625, in some embodiments, IoT processor 145 may be configured to retrieve the passcode 220 from the cryptographic storage on IoT computer chip module 140. At step 630, in some embodiments, IoT processor 145 may be configured to retrieve the encrypted TAP 225 (e.g., encrypted with the passcode 220), which was previously stored in a dedicated folder on the IoT computer chip module 140. At step 635, in some embodiments, IoT processor 145 may be configured to decrypt TAP 225 using passcode 220. At step 640, in some embodiments, IoT processor 145 may be configured to, extract the activation code 220 from TAP 225, and at step 645, in some embodiments, IoT processor 145 may be configured to compare the activation code transmitted with the run command with the activation code in the decrypted TAP 225.

If the two activation codes are identical, then at step 650, in some embodiments, IoT processor 145 may be configured to load the application 210 into an environment for running applications on IoT computer chip module 140 (e.g., Telit® IoT AppZone), and at step 655, IoT processor 145 may be configured execute the application. At step 660, in some embodiments, a message or other indication may be sent to system server 110, indicating that the application has been executed on IoT computer chip module 140. If the two activation codes are not identical, then at step 665, in some embodiments, IoT processor 145 may be configured to discard the command, and at step 670, in some embodiments, a message or other indication may be sent to system server 110, indicating that the activation code is invalid.

While the methods as described in relation to FIG. 6 refer to a run command, it will be understood by those skilled in the art that the same or similar methods may be performed when executing other commands such as, for example, a read command, an override/write command, and/or other similar commands. For example, in some embodiments, server processor 115 and/or IoT processor 145 may be configured to retrieve activation code 215 from the memory; transmit a read command and the activation code 215 to the IoT computer chip module 140, upon receiving the read command and the activation code 215, retrieve the passcode 220 from the cryptographic storage, retrieve the TAP 225 from the dedicated folder, decrypt the TAP 225 using the passcode 220, compare the activation code transmitted with the read command with the activation code in the TAP 225, and read the application from the dedicated folder only when the two activation codes are identical. Similarly, in some embodiments, server processor 115 and/or IoT processor 145 may be configured to retrieve activation code 215 from the memory; transmit an override/write command and the activation code 215 to the IoT computer chip module 140, upon receiving the override/write command and the activation code 215, retrieve the passcode 220 from the cryptographic storage, retrieve the TAP 225 from the dedicated folder, decrypt the TAP 225 using the passcode 220, compare the activation code transmitted with the override/write command with the activation code in the TAP 225, and override and/or write to the application only when the two activation codes are identical.

FIG. 7 is a high-level diagram illustrating an example configuration of a method workflow 700 for deleting an application when managing a trusted application in a computer chip module, according to at least one embodiment of the invention. In some embodiments, at step 705, a processor, e.g., server processor 115, of a user (e.g., user 205) may be configured (e.g., using one or more code sets stored in the memory and executing in the processor) to retrieve the previously stored activation code, e.g., activation code 215, from storage. At step 710, in some embodiments, server processor 115 may be configured to transmit a delete command and the activation code 215 to IoT computer chip module 140 to delete the trusted application stored on IoT computer chip module 140. For example, the command may be an AT command such as AT #M2MDel (e.g., for wireless communication commands), along with the retrieved activation code 215. Of course, other commands are also contemplated, e.g., when communications are facilitated via a local interface or physically connected (serial) connection/interface. At step 715, in some embodiments, IoT processor 145 may be configured to parse the received command to identify the application 210, and at step 720, in some embodiments, IoT processor 145 may be configured to parse the received command to identify the received activation code 215.

Next, at step 725, in some embodiments, IoT processor 145 may be configured to retrieve the passcode 220 from the cryptographic storage on IoT computer chip module 140. At step 730, in some embodiments, IoT processor 145 may be configured to retrieve the encrypted TAP 225 (e.g., encrypted with the passcode 220), which was previously stored in a dedicated folder on the IoT computer chip module 140. At step 735, in some embodiments, IoT processor 145 may be configured to decrypt TAP 225 using passcode 220. At step 740, in some embodiments, IoT processor 145 may be configured to, extract the activation code 220 from TAP 225, and at step 745, in some embodiments, IoT processor 145 may be configured to compare the activation code transmitted with the delete command with the activation code in the decrypted TAP 225.

If the two activation codes are identical, then at step 750, in some embodiments, IoT processor 145 may be configured to delete the application 210. At step 755, in some embodiments, a message or other indication may be sent to system server 110, indicating that the application has been deleted from IoT computer chip module 140. If the two activation codes are not identical, then at step 760, in some embodiments, IoT processor 145 may be configured to discard the command, and at step 765, in some embodiments, a message or other indication may be sent to system server 110, indicating that the activation code is invalid.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A method for managing a trusted application in a computer chip module, the method performed on a computer having a processor, memory, and one or more code sets stored in the memory and executing in the processor, the method comprising:
generating, by the processor, a trusted application package (TAP), the TAP comprising an application and an activation code, wherein the TAP is encrypted with a passcode and wherein the activation code is stored in the memory of the computer;
receiving from the computer chip module a public key, wherein the public key is part of a pair of asymmetrical transport keys generated by the computer chip module, and wherein the pair of asymmetrical transport keys further comprises a private key;
encrypting, by the processor, the passcode with the public key;
transmitting, by the processor, the encrypted passcode to the computer chip module, wherein the computer chip module is configured to decrypt the passcode using the private key; and
transmitting, by the processor, the TAP to the computer chip module, wherein the TAP is stored in a dedicated folder on the computer chip module.

2. The method as in claim 1, wherein the transmissions are via a wireless network.

3. The method as in claim 1, wherein the transmissions are via at least one of a local interface and a physically connected serial connection.

4. The method as in claim 1, wherein the passcode is stored in a cryptographic storage on the computer chip module.

5. The method as in claim 1, further comprising:
retrieving, by the processor, the activation code from the memory; and
transmitting, by the processor, a run command and the activation code to the computer chip module;
wherein, upon receiving the run command and the activation code, the computer chip module is configured to:
retrieve the passcode from the cryptographic storage;
retrieve the TAP from the dedicated folder;
decrypt the TAP using the passcode;
compare the activation code transmitted with the run command with the activation code in the TAP; and
execute the application only when the two activation codes are identical.

6. The method as in claim 5, wherein the application is executed in a dedicated application environment in the computer chip module.

7. The method as in claim 1, further comprising:
retrieving, by the processor, the activation code from the memory; and
transmitting, by the processor, a read command and the activation code to the computer chip module;
wherein, upon receiving the read command and the activation code, the computer chip module is configured to:
retrieve the passcode from the cryptographic storage;
retrieve the TAP from the dedicated folder;
decrypt the TAP using the passcode;
compare the activation code transmitted with the read command with the activation code in the TAP; and
read the application only when the two activation codes are identical.

8. The method as in claim 1, further comprising:
retrieving, by the processor, the activation code from the memory; and
transmitting, by the processor, an override/write command and the activation code to the computer chip module;
wherein, upon receiving the override/write command and the activation code, the computer chip module is configured to:
retrieve the passcode from the cryptographic storage;
retrieve the TAP from the dedicated folder;
decrypt the TAP using the passcode;
compare the activation code transmitted with the override/write command with the activation code in the TAP; and
at least one of override and write to the application only when the two activation codes are identical.

9. The method as in claim 1, further comprising:
retrieving, by the processor, the activation code from the memory; and
transmitting, by the processor, a delete command and the activation code to the computer chip module;
wherein, upon receiving the delete command and the activation code, the computer chip module is configured to:
retrieve the passcode from the cryptographic storage;
retrieve the TAP from the dedicated folder;
decrypt the TAP using the passcode;
compare the activation code transmitted with the delete command with the activation code in the TAP; and
delete the application from the dedicated folder only when the two activation codes are identical.

10. The method as in claim 1, wherein the computer chip module is integrated in an Internet-of-Things (IoT) device.

11. A system for managing a trusted application in a computer chip module, comprising:
a computer having a processor and memory, and
one or more code sets stored in the memory and executing in the processor, which configure the processor to:
generate a trusted application package (TAP), the TAP comprising an application and an activation code, wherein the TAP is encrypted with a passcode and wherein the activation code is stored in the memory of the computer;
receive from the computer chip module a public key, wherein the public key is part of a pair of asymmetrical transport keys generated by the computer chip module, and wherein the pair of asymmetrical transport keys further comprises a private key;
encrypt the passcode with the public key;
transmit the encrypted passcode to the computer chip module, wherein the computer chip module is configured to decrypt the passcode using the private key; and
transmit the TAP to the computer chip module, wherein the TAP is stored in a dedicated folder on the computer chip module.

12. The system as in claim 11, wherein the transmissions are via a wireless network.

13. The system as in claim 11, wherein the transmissions are via at least one of a local interface and a physically connected serial connection.

14. The system as in claim 11, wherein the passcode is stored in a cryptographic storage on the computer chip module.

15. The system as in claim 11, wherein the processor is further configured to:
retrieve the activation code from the memory; and
transmit a run command and the activation code to the computer chip module;
wherein, upon receiving the run command and the activation code, the computer chip module is configured to:
retrieve the passcode from the cryptographic storage;
retrieve the TAP from the dedicated folder;
decrypt the TAP using the passcode;
compare the activation code transmitted with the run command with the activation code in the TAP; and
execute the application only when the two activation codes are identical.

16. The system as in claim 15, wherein the application is executed in a dedicated application environment in the computer chip module.

17. The system as in claim 11, wherein the processor is further configured to:
retrieve the activation code from the memory; and
transmit a read command and the activation code to the computer chip module;
wherein, upon receiving the read command and the activation code, the computer chip module is configured to:
retrieve the passcode from the cryptographic storage;
retrieve the TAP from the dedicated folder;
decrypt the TAP using the passcode;
compare the activation code transmitted with the read command with the activation code in the TAP; and
read the application only when the two activation codes are identical.

18. The system as in claim 11, wherein the processor is further configured to:
retrieve the activation code from the memory; and
transmit an override/write command and the activation code to the computer chip module;
wherein, upon receiving the override/write command and the activation code, the computer chip module is configured to:
retrieve the passcode from the cryptographic storage;
retrieve the TAP from the dedicated folder;
decrypt the TAP using the passcode;
compare the activation code transmitted with the override/write command with the activation code in the TAP; and
at least one of override and write to the application only when the two activation codes are identical.

19. The system as in claim 11, wherein the processor is further configured to:
retrieve the activation code from the memory; and
transmit a delete command and the activation code to the computer chip module;
wherein, upon receiving the delete command and the activation code, the computer chip module is configured to:
retrieve the passcode from the cryptographic storage;
retrieve the TAP from the dedicated folder;
decrypt the TAP using the passcode;
compare the activation code transmitted with the delete command with the activation code in the TAP; and
delete the application from the dedicated folder only when the two activation codes are identical.

20. The system as in claim 11, wherein the computer chip module is integrated in an Internet-of-Things (IoT) device.
